(19) United States
(12) Patent Application Publication
(10) Pub. No.: US 2007/0172231 A1
(43) Pub. Date: Jul. 26, 2007

(54) Rotor magnet driven optical shutter assembly

(75) Inventor: David W. Durfee, Rochester, NY (US)

Correspondence Address: BROWN & MICHAELS, PC;400 M & T BANK BUILDING, 118 NORTH TIOGA ST, ITHACA, NY, 14850, US

(73) Assignee: Melles Griot, Inc., Rochester, NY (US)

(21) Appl. No.: 11/340,044

(22) Filed: Jan. 26, 2006

(51) Int. Cl. G03B 9/08

(52) U.S. Cl. 396/463

(57) ABSTRACT

A rotor magnet driven optical shutter assembly with a permanent magnet rotor directly connected to and driving the rotation of an optical shutter blade, to alternately block or allow transmission of light through the shutter aperture. The rotor is cylindrical with optional center hole, is magnetized across its diameter, and rotates around a pivot bearing coaxial with its center axis. A stator is arranged around the rotor and is shaped so that, as the rotor rotates over its range of travel, the flux through the electromagnet drive coil core varies in magnitude and direction. A drive current through the electromagnet drive coil thus induces a torque to the rotor, to open or close the shutter blade. By driving the electromagnet drive coil with a controlled current waveform, the shutter aperture may be opened or closed (either quickly or slowly), held open/closed, or moved to any intermediate position, as desired.

### BACKGROUND OF THE INVENTION

1. Field of the Invention

The invention pertains to the field of electro-magnetically driven optical shutters. More particularly, the invention pertains to a means for opening and closing one or more blades of an optical shutter where the optical shutter blades are directly connected to a rotor magnet.

2. Description of Related Art

The prior art is replete with examples of electro-magnetically actuated optical shutters. Representative examples of prior art in this area include the following U.S. patents:
U.S. Pat. No. 4,720,726 describes a shutter driving apparatus using a driving current pulse.
U.S. Pat. No. 4,864,346 describes a shutter driving apparatus using pulses to actuate the shutter back and forth.
U.S. Pat. No. 4,864,347 describes a shutter control apparatus using varying pulse rates to vary actuation of the shutter.
U.S. Pat. No. 4,984,003 describes a shutter driving apparatus using a constant current circuit and a variable current circuit in combination.
U.S. Pat. No. 5,155,521 describes a shutter control apparatus using a sequence of pulsed current components.
U.S. Pat. No. 6,017,156 describes a shutter driving apparatus including a stator and an annular rotor or an annular stepper.
U.S. Pat. No. 6,139,202 describes a magnetic rotor directly coupled to the shutter mechanism.
U.S. Pat. No. 6,903,777 describes a shutter for a digital camera with a motor having a driving pin integrally provided with a permanent magnetic rotor in such a manner as to extend in parallel with a rotation shaft of the rotor.
U.S. Patent Publication No. 2005/0195315 describes a shutter driving apparatus with an exciting electromagnet drive coil for driving the shutter between a closed and an open position.
   However, most of the aforesaid prior art arrangements of electromagnetic drives for optical shutter actuation involve solenoids, which have inherently very non-linear force curves and low energy efficiency. This leads to the disadvantages of high heat, high current draw, high impact (and drive linkage wear), and poor speed/position/force control. Further, many of the prior art arrangements described also involve complex linkages to drive blades, with resulting higher cost, lower reliability, lower durability, and many geometric limits to design layout and arrangement. Finally, even though some of the prior art shutter drive arrangements described use moving magnet (i.e., stepper motor) drives, none offers a simple robust permanent rotor magnet direct drive system that is inherently advantageous due to its inherent reliability, long life, design flexibility, and low-cost manufacturability.

### SUMMARY OF THE INVENTION

In its most basic form, the present invention utilizes a magnetic rotor directly connected to and driving the rotation of an optical shutter blade, to alternately block or allow transmission of light through the shutter. The rotor is disk-shaped with optional center hole. It is magnetized across its diameter and rotates around a pivot bearing coaxial with its center axis. An iron structure (stator) is arranged around the rotor and conducts magnetic flux from the rotor through the iron core of one or more electromagnet drive coils. The stator shape is arranged so that, as the rotor rotates over its range of travel, the flux through the electromagnet drive coil core varies in magnitude and direction. A drive current through the electromagnet drive coil thus induces a torque to the rotor, to open or close the shutter blade. The drive torque is roughly proportional to the rate of flux change (per degree of rotor rotation) and the current though the coil. By driving the electromagnet drive coil with a controlled current waveform, the shutter aperture may be opened or closed (either quickly or slowly), held open/closed, or moved to any intermediate position, as desired.

There are stepper motors, particularly electric watch motor drives, that use somewhat similar magnetic circuitry to drive rotors in a step-wise motion. However, the instant invention (to the extent it might be compared to such motors) is novel and non-obvious in its application of a magnetic rotor to directly drive a shutter blade for bidirectional, limited-stroke actuation where the shutter blade is preferably rigidly connected (in terms of rotational motion but not necessarily in terms of axial motion) to the rotor. These features, alone and/or in combination in the basic embodiments of the invention, as well as in combination with one-sided bearing support, travel stops, magnetic bias/latching and/or other enhancements and variations described herein with respect to the preferred embodiments lead to a magnetic rotor shutter drive that is simple, robust, inherently reliable, has long life, design flexibility, and low-cost manufacturability.

### BRIEF DESCRIPTION OF THE DRAWING

FIG. 1A provides a schematic illustration of a basic embodiment of the actuating system of the invention.

FIG. 1B provides a schematic illustration of the basic embodiment of the actuating system of the invention illustrated in FIG. 1A with its electromagnet stator and rotor creating torque in a first direction.

FIG. 1C provides a schematic illustration of the basic embodiment of the actuating system of the invention illustrated in FIG. 1A with its electromagnet stator and rotor creating torque in a second direction.

FIG. 1D provides a schematic illustration of the basic embodiment of the actuating system of the invention after the current flow establishing it in the position illustrated in FIG. 1B has terminated, with zero torque on the rotor and only the rotor's magnetic flux remaining in the magnetic flux loop formed by the stator.

FIG. 1E provides a schematic illustration of the basic embodiment of the actuating system of the invention after the current flow establishing it in the position illustrated in FIG. 1C has terminated, with zero torque on the rotor and only the rotor's magnetic flux remaining in the magnetic flux loop formed by the stator.

FIG. 2 provides an exploded schematic perspective illustration of a preferred embodiment of the invention with a single shutter blade.

FIG. 3A provides a perspective illustration of a rotor stop plate and a drive hub of the invention in operative positions with the tabs of the drive hub at a first limit imposed by the rotor stop plate.

FIG. 3B provides a perspective illustration of a rotor stop plate and a drive hub of the invention in operative positions with the tabs of the drive hub at a second limit imposed by the rotor stop plate.

FIG. 4A provides a partially exploded schematic perspective illustration of a preferred embodiment of the invention with a single shutter blade shown in conjunction with an aperture plate having an aperture, and said shutter blade in an open position with respect to an aperture.

FIG. 4B provides a partially exploded schematic perspective illustration of the preferred embodiment of the invention illustrated in FIG. 4A, with said shutter blade in a partially open position with respect to the aperture.

FIG. 4C provides a partially exploded schematic perspective illustration of the preferred embodiment of the invention illustrated in FIG. 4A, with said shutter blade in a closed position with respect to the aperture.

FIG. 5A provides a perspective illustration of the embodiment and shutter position of FIG. 4A with shutter stops limiting the motion of said shutter blade.

FIG. 5B provides a perspective illustration of the embodiment and shutter position of FIG. 4B with shutter stops limiting the motion of said shutter blade.

FIG. 5C provides a perspective illustration of the embodiment and shutter position of FIG. 4C with shutter stops limiting the motion of said shutter blade.

FIG. 6A provides a partially exploded perspective view of a first example of a multi-blade shutter with the shutter blades open. The shutters and rotors are evenly spaced and on opposite sides of the aperture. As illustrated, crescent shaped shutters are advantageously used in this embodiment.

FIG. 6B provides a partially exploded perspective view of a first example of a multi-blade shutter with the shutter blades closed.

FIG. 7 provides a perspective view of a multi-blade shutter assembly (sans shutter blades) with its plurality of rotors and stators arranged in series. The rotors are evenly spaced around the aperture.

FIG. 8A provides a perspective view of a multi-blade shutter assembly (sans shutter blades) with its plurality of rotors and stators arranged in series and with linking stators as well as driving stators. Pairs of rotors are evenly spaced around the aperture.

FIG. 8B illustrates a possible shutter arrangement for the embodiment illustrated in FIG. 8A. The three pairs of rotors are driven by three coils with the overall arrangement allowing closely spaced flush mounted blade pairs that can overlap rotor axes.

FIG. 9 illustrates a possible shutter arrangement for an embodiment having one group of shutters located on one side of an aperture. This is another compact blade arrangement with closely spaced overlapping blades made possible by using multiple rotors per coil and flush-mounted blades.

FIG. 10 illustrates a possible shutter arrangement for an embodiment having two groups of shutters located on opposite sides of an aperture. This is still another compact blade arrangement with closely spaced overlapping blades made possible by using multiple rotors per coil and flush-mounted blades.

FIG. 11 provides a perspective view of a multi-blade shutter assembly (sans shutter blades) with its plurality of rotors and stators arranged in parallel.

FIG. 12A provides a perspective view of a rotor hub joined to the rotor magnet or a rotor magnet assembly by a ferrule.

FIG. 12B provides a side view of the combination illustrated in FIG. 12A.

FIG. 12C provides a cross-sectional view of the combination illustrated in FIG. 12B.

FIG. 13 provides a perspective view of a rotor hub joined to the rotor magnet of a rotor magnet assembly by hub snaps.

FIG. 14 provides a perspective view of a shutter blade directly bonded to a rotor magnet.

FIG. 15 provides a perspective view of a shutter blade with a drive tab for use in connecting the blade to a keyed rotor hub.

FIG. 16A illustrates a constant reluctance rotor stator combination.

FIG. 16B illustrates a variable reluctance rotor stator combination.

FIG. 17 provides a side view of an arrangement where the rotor magnet is axially offset from its stator. In this embodiment natural magnetic attraction pulls the rotor towards a position centered in the stator, pressing it against its mounting bearing and thereby helping to retain the rotor in position.

FIG. 18 illustrates a pulsing current used to drive the coil of the invention and the acceleration of a shutter based on said pulsing current.

FIG. 19A illustrates a pulsing AC current with a (+) dominant time ratio leading to torque and shutter blade motion in a certain direction.

FIG. 19B illustrates a pulsing AC current with a (−) dominant time ratio leading to torque and shutter blade motion in a direction opposite from that in FIG. 19B.

### DETAILED DESCRIPTION OF THE INVENTION

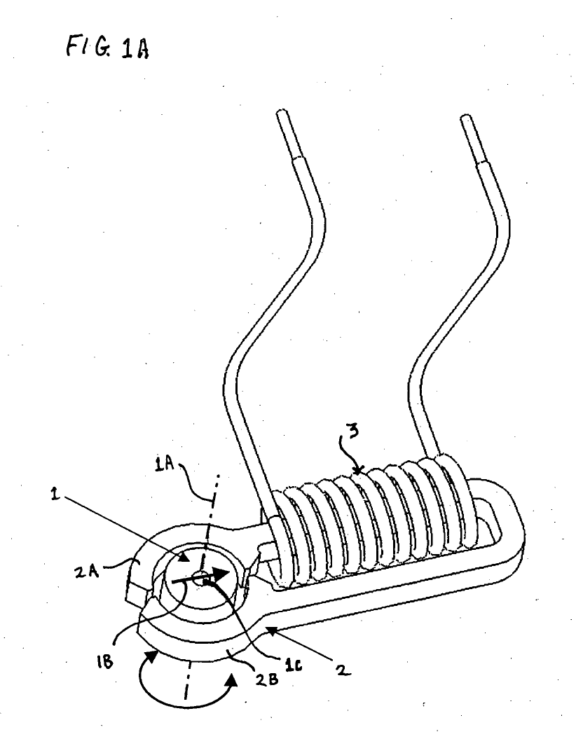

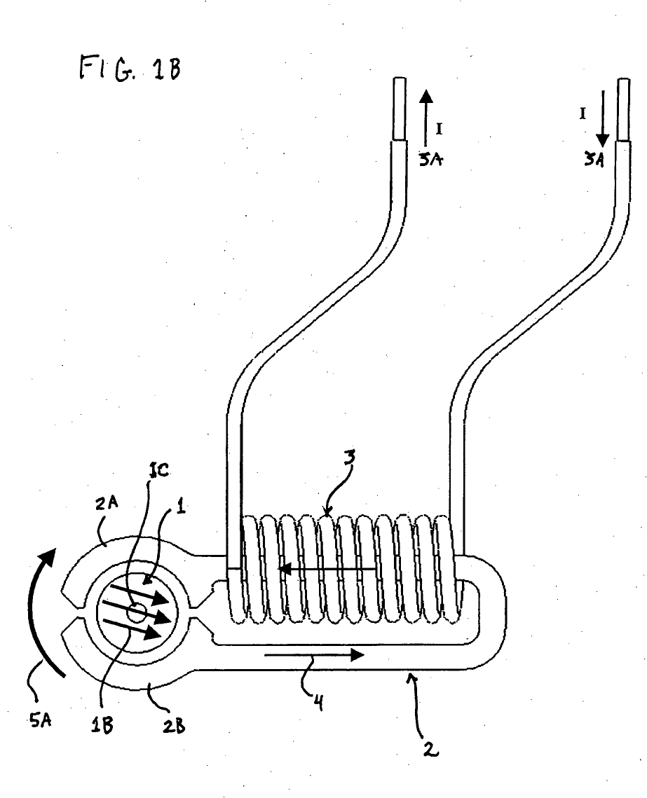

The basic underlying principles of the invention, as initially set forth in the summary of the invention, can be better understood by reference to FIGS. 1A, 1B, and 1C. In FIG. 1A, a cylindrical rotor magnet 1 rotatable on a central axis 1A and having a polarization denoted by polarization indicator arrow 1B is positioned between first pole 2A and second pole 2B of two arms of a stator 2. (In this specification and in the claims that follow, the term “magnet” is reserved for a non-electromagnet). The position of rotor magnet 1—as indicated by arrow 1B—is initially and illustratively set at a neutral point between poles 2A and 2B in order to show the torques produced by different magnetic polarizations of stator 2. Stator 2 is, in turn, wrapped by an electromagnet drive coil 3 such that its can serve as an electromagnet with its polarization determined by the direction of current in electromagnet drive coil 3.

In FIG. 1B, the direction of current flow through electromagnet drive coil 3 is indicated by current indicator arrows 3A. As will be noted, this polarizes the stator 2, creating a magnetomotive force (an “MMF”) as indicated by MMF arrows 4 which, in turn, creates a torque 5A on rotor magnet 1. Likewise, when the direction of current flow through electromagnet drive coil 3 is reversed, as indicated current indicator arrows 3B in FIG. 1C, the direction of MMF arrows 4 and torque 5A on rotor magnet 1 is also reversed. And, when there is no current through the electromagnet drive coil 3, and constant reluctance through the magnetic flux loop created by stator 2, rotor magnet 1 will experience zero torque. (See, FIGS. 1D and 1E). Thus, by connection of a shutter to magnet rotor 1, its motion can be changed, directed, or maintained in similar manner, by changing, ending or reversing the current flow through electromagnet drive coil 3.

FIG. 2 illustrates a basic rotor driven shutter assembly based on the aforesaid principles. In this figure, rotor 1 is provided with a pivot bearing base 6 designed to interface with rotor 1 and its center hole 1C, allowing rotor magnet 1 to rotate freely around its central axis 1A. Preferably, stator 2 is slightly offset axially by a distance “1” from rotor magnet 1 so as to pull the rotor magnet 1 tightly against pivot bearing base 6 (which serves as a thrust bearing). (See, FIG. 17). This allows a bearing on one side only (as illustrated in the drawing figures). This, in turn, allows direct attachment of shutter blade 8 on the other side of rotor magnet 1. With proper attachment of shutter blade 8 to rotor magnet 1 the attachment of the blade 8 to rotor magnet 1 can be completely smooth on the outward side. And, the fact that the rotor magnet 1 is supported on only one side, allows an arrangement of multiple shutter blades which overlap one another, even at their pivot points (i.e., centers of rotation). This, as will be particularly seen in the multi-blade embodiments discussed below, permits great flexibility in shutter design, allowing a very simple yet compact shutter (small OD any given ID), a very significant advantage.

Another basic feature of the preferred embodiments, also illustrated in FIG. 2, is the presence of a blade drive hub 7 affixed to the top of rotor magnet 1, which serves as an interface element between rotor magnet 1 and shutter blade 8. A rotor stop plate 9 is provided around the periphery of drive hub 7. This plate has travel limiting channels 9A for drive hub tabs 7A, limiting the movement of tabs 7A as drive hub 7 rotates around axis 1A and thereby limiting the rotation of rotor magnet 1 and other elements of the system as well. (See, e.g., FIGS. 3A and 3B, illustrating the limits or rotation imposed on tabs 7A and by them on the whole system by travel limiting channels 9A). Drive hub 7 also has interface elements (e.g., center post and wings 7B) on its top to interface with interlocking elements (e.g., holes and slots 8A) on shutter blade 8. However, while this type of interface creates a rigid connection in terms of rotational motion, it does not necessarily bar axial motion of blade 8 away from rotor 1. Depending on application, this may be desirable. If not, blade 8 can easily be held in position by elements placed above it, by bonding it to hub 7, and/or by otherwise affixing it in position.

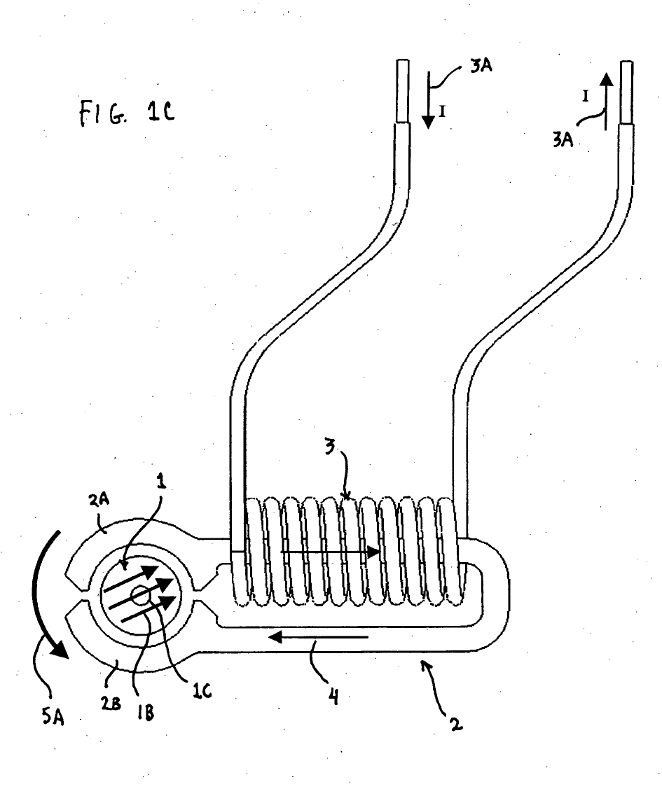

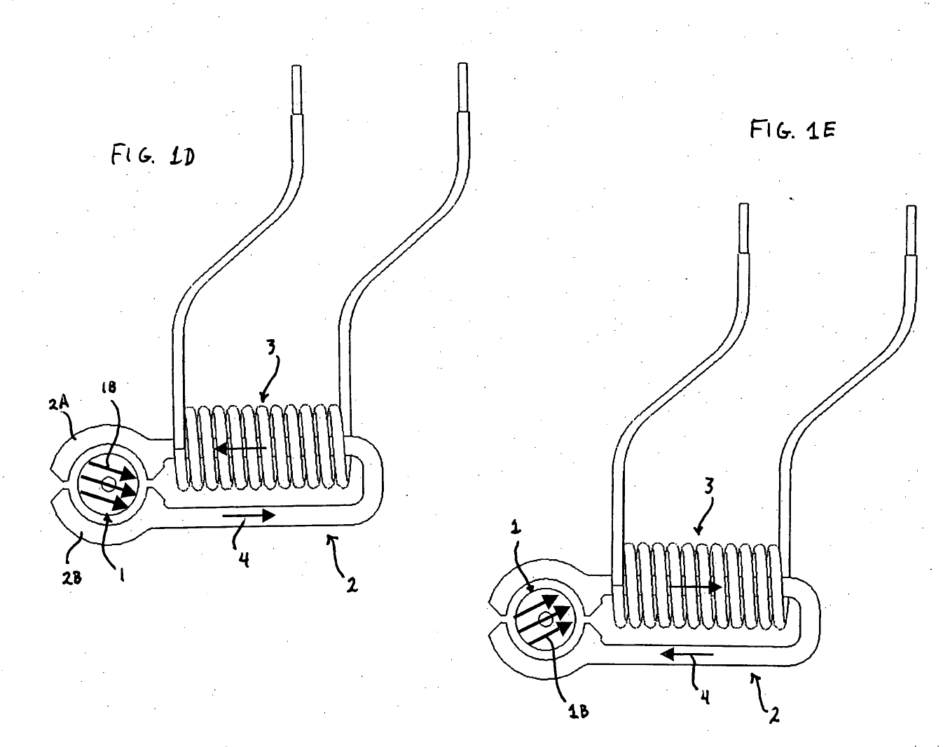

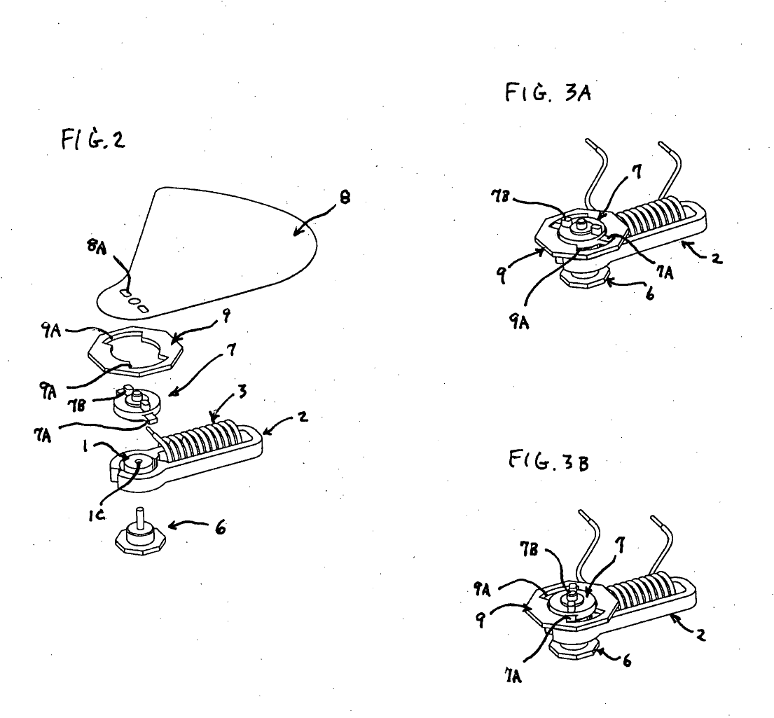

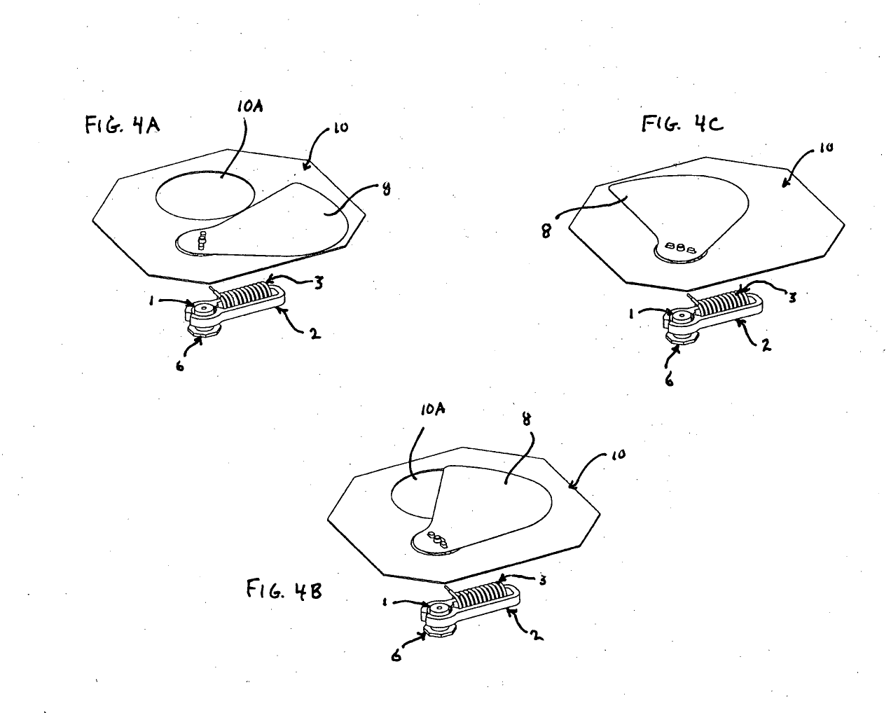

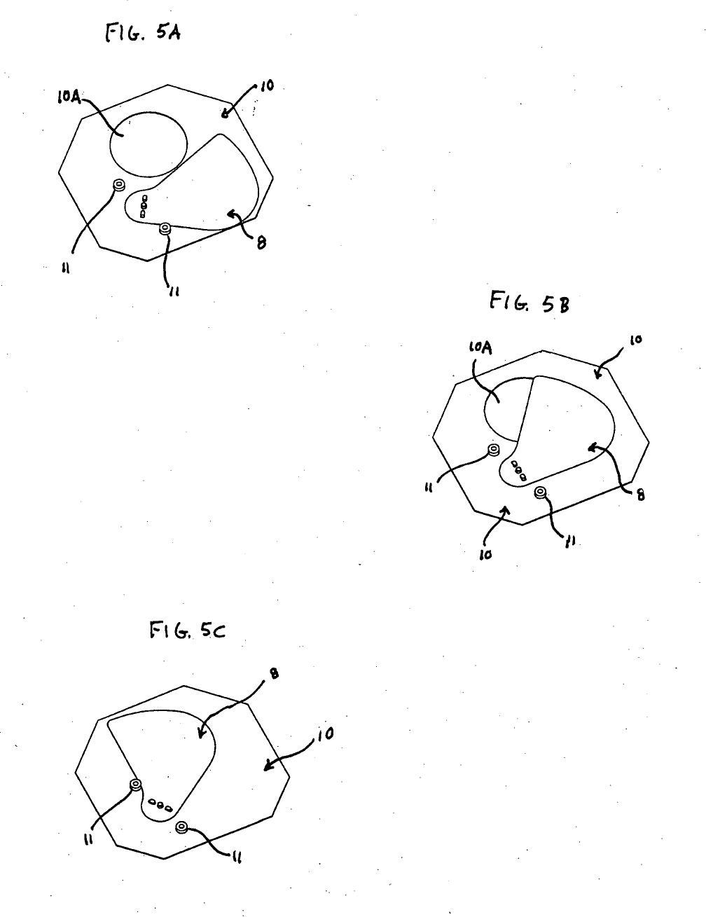

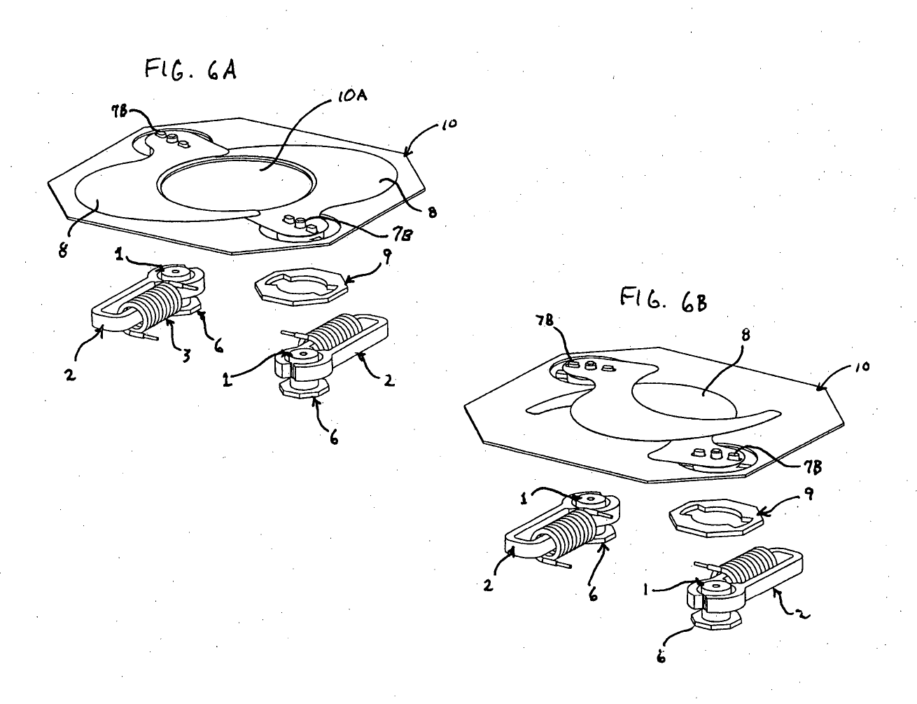

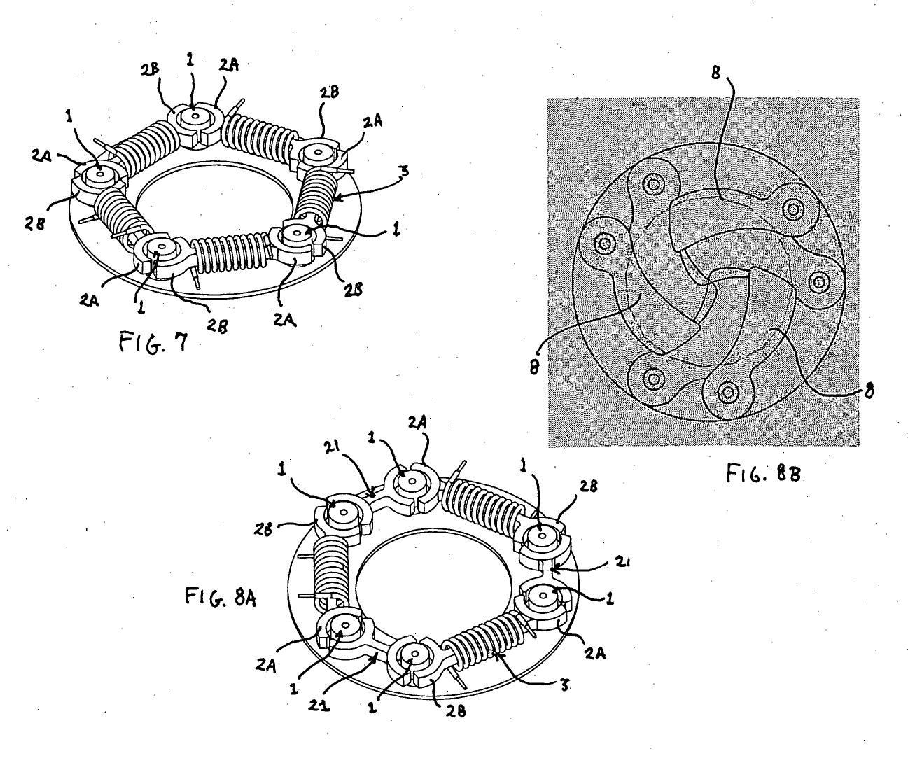

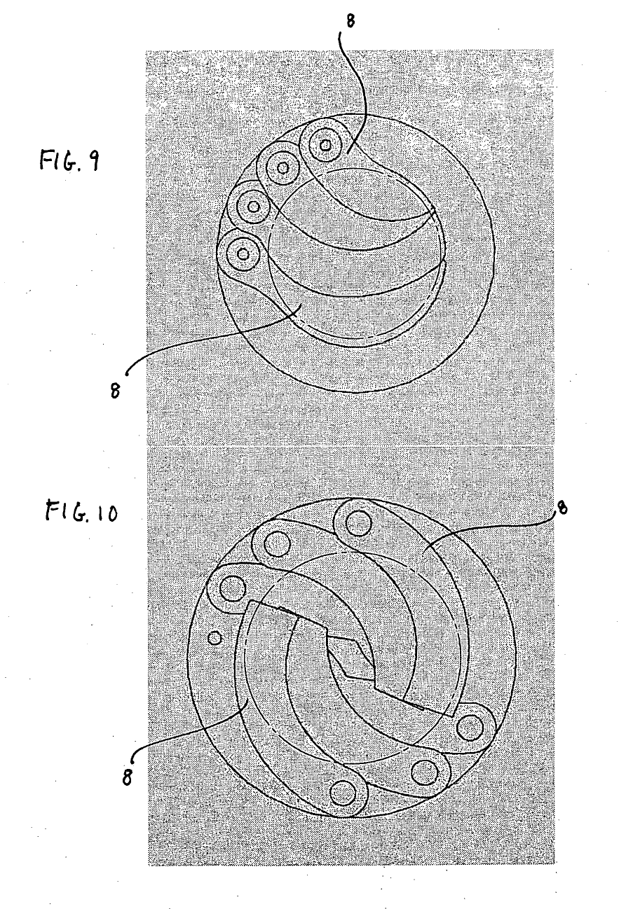

FIGS. 4A through 4C illustrate the basic rotor driven shutter assembly of FIG. 2 in conjunction with an aperture plate 10 having an aperture 10A. In the sequence illustrated in these figures, FIG. 4A illustrates the shutter blade 8 in open position with aperture 10A exposed, while FIG. 4B illustrates it in the process of closing and/or partially closed with aperture 10A partially exposed, and FIG. 4C illustrates shutter blade 8 in closed position with aperture 10A fully covered. Next, as illustrated by the identical sequence illustrated in FIGS. 5A through 5C, shutter stops 11 can be provided to limit the motion of shutter blade 8 (and thereby of the system as a whole) as it swings between open and closed positions as a supplement to or in place of the travel limiting system previously described with respect to tabs 7A and travel limiting channels 9A.

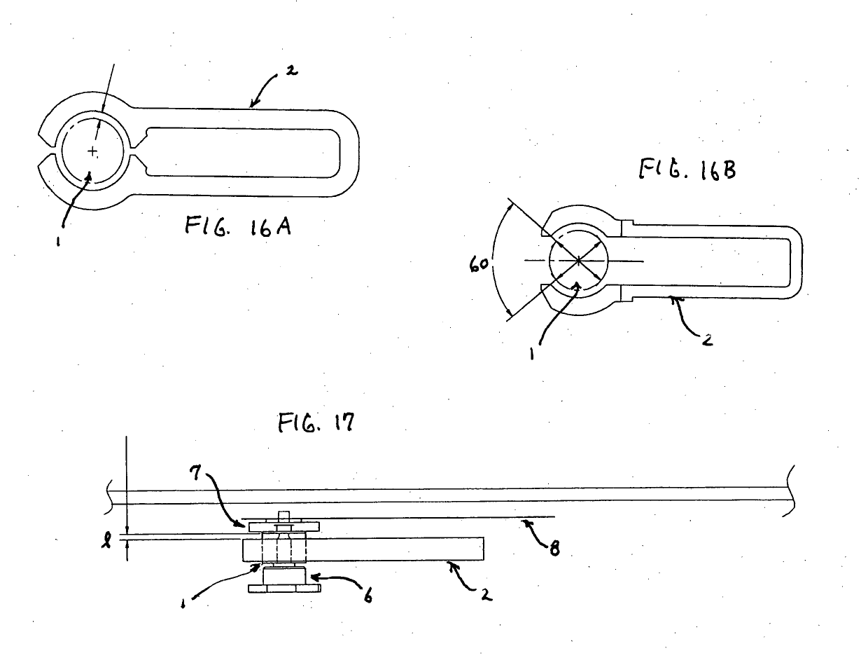

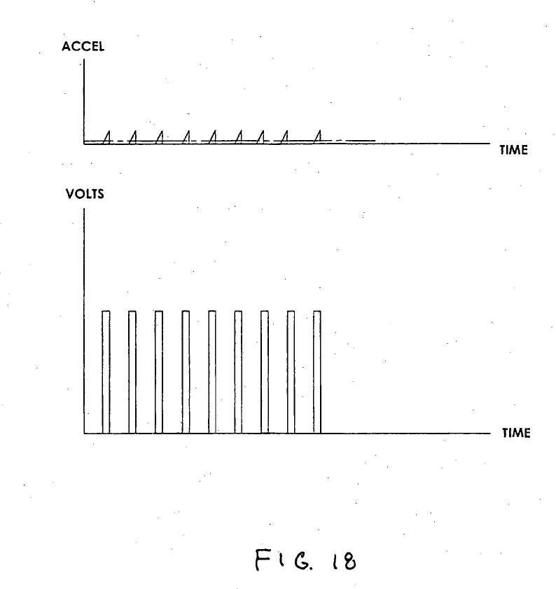

Thus, the rotation of shutter blade 8 may be limited by mechanical stops, which may stop directly against the blade (as illustrated in FIGS. 5A through 5C), against the rotor magnet 1, and/or against a lever arm attached to the rotor magnet 1 (as illustrated in FIGS. 2 through 3B). Mechanical stops may be hard (for sudden stop), may be flexible/elastomeric (for a softer stop), and/or may provide a dampened soft stop (i.e., via urethane or other dampened elastomer with high stress/strain hysteresis) for faster settling, less blade bounce, less impact wear and/or less noise. Also, as discussed in more detail below, the stator may be shaped to pull the rotor magnet towards a stop. (See, e.g., FIG. 16B, below and accompanying text).

Turning to FIGS. 6A through 11, which illustrate other possible (and generally more complex) preferred embodiments, it is clear that a shutter produced in accordance with the invention may use one or multiple rotors 1 and blades 8, and that the blades 8 used can vary in shape, all depending on space envelope limits, cost and manufacturing trade-offs. Likewise, multiple rotor magnets 1 can be individually powered and controlled (as illustrated in FIGS. 4A through 6B), rotors 1 can be in a series magnetic circuit driven by one or more coils 3 (as illustrated in FIGS. 7 through 8B), and/or rotors 1 can be arranged in a parallel magnetic circuit driven by one or more coils (as illustrated in FIG. 11). Various series arrangements may also feature linking stators 20 that are not wound by coils 3, as illustrated in FIGS. 8A and 8B. Further, shutter blades 8 can be symmetrically or asymmetrically arranged, arranged singly or in groups, and can otherwise be subject to a wide variety of arrangements as need and convenience dictates. (See, generally, e.g., FIGS. 2 through 11). Thus, the invention provides immense flexibility and allows a wide variety of rotor arrangements, blade designs, and blade placements. Depending on shutter application, any of these different arrangements may be preferred for lowest cost, most compact physical arrangement and/or highest energy efficiency.

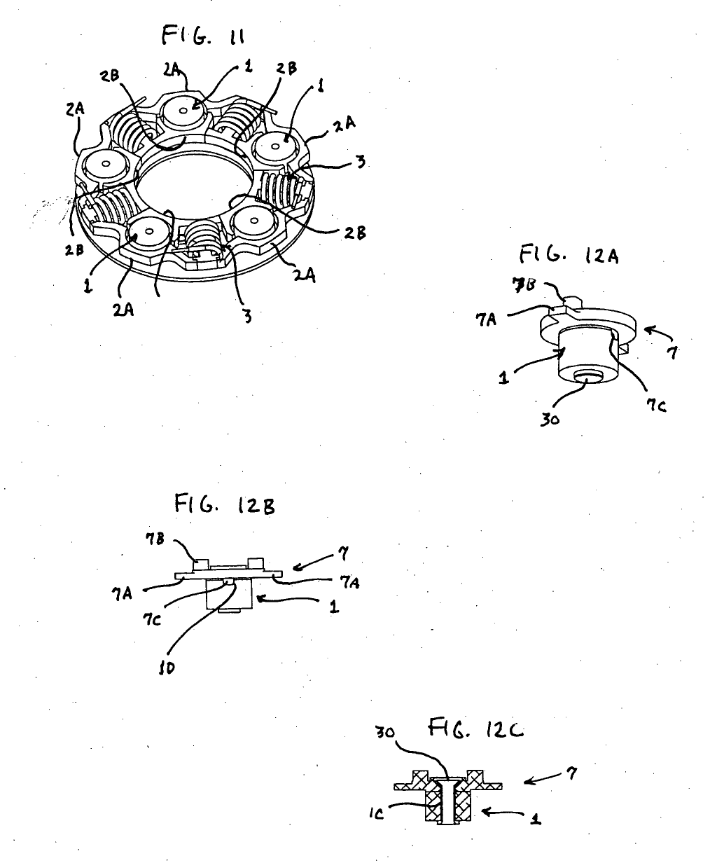

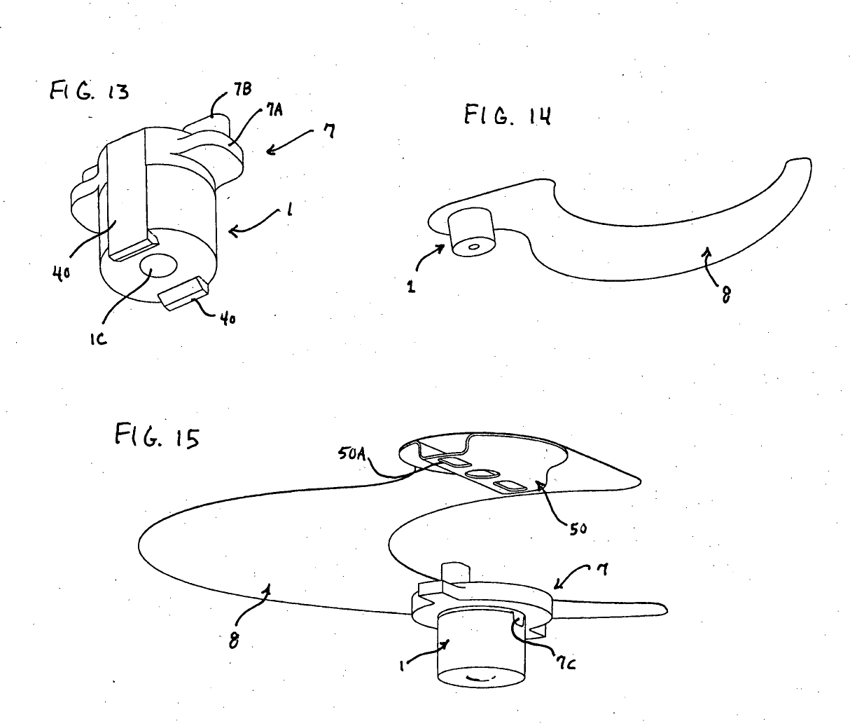

FIGS. 12A through 15 provide further insight into some of the ways in which the rotor 1 and blade 8 may be linked. FIGS. 12A through 12C illustrate an embodiment having a drive hub 7 with a linking tab 7C that mates with a slot 1D in the top of rotor magnet 1. A flared ferule 30, which runs through center hole 1C, holds the assembly together and extends below the bottom of rotor 1 so that it can act as a bearing on a pivot post. Alternatively, instead of using a flared ferrule 30, the rotor 1 could be insert molded into drive hub 7. Likewise, it would be possible to support rotor 1, hub 7, and blade 8 via a shaft going through all parts with bearing sleeves at either end. (However, this alternative would not allow for closely spaced blades 8 overlapping rotor axes 1A, losing some of the benefits of the invention). FIGS. 13 and 14 illustrate still other possibilities, with FIG. 13 illustrating a hub 7 that has snaps 40 that fit into notches in rotor 1 and FIG. 14 illustrating a blade 8 directly bonded to a rotor 1 via, e.g., adhesive or spot welding. Finally, FIG. 15 illustrates what is probably the preferred method for flush mounting blades 8. In this figure, a drive bracket 50 with holes and slots 50A is provided on a blade 8 to allow it to interface with center post and wings 7B

By varying the design of stator 2, particularly with regard to poles 2A, 2B a bias or torque can be created that will return the shutter blade 8 to a desired position, or will hold the blade 8 in position when drive current is removed. Thus, in one variation the shape of poles 2A, 2B may be generally round with a relatively small and constant gap between poles 2A, 2B and rotor 1 producing a constant magnetic reluctance (as illustrated in FIG. 16A). This gives nearly zero bias torque and can be used for bipolar drive applications. (However, external bias and/or latching means such a springs, detents, or external magnets can be added to the rotor hub assembly to provide a particular bias if desired). The shapes of poles 2A, 2B can also be intentionally varied via notches, protrusions, or changes in radius (for variable reluctance as illustrated in FIG. 16B), in order to provide a torque bias, and/or magnetic “detent” latching action to pull the blade 8 or some other part of the assembly against a stop at either or both ends of travel. In FIG. 16B, the change in radius is the product of large gaps 60. Low reluctance zones (where there is a shorter distance between rotor 1 and magnetic poles 2A, 2B) cause rotor 1 to pull towards the closest of two positions adjacent a pole 2A, 2B. This tends to “latch” the rotor 1 in full open or closed positions (and to cause the shutter to hold that position without power) and is useful for bipolar-drive applications requiring bi-stable (i.e., “latching”) functionality. In addition, a permanent magnet may be added to the stator 2 “circuit” (in series with coil 3), in order to provide a bias torque.

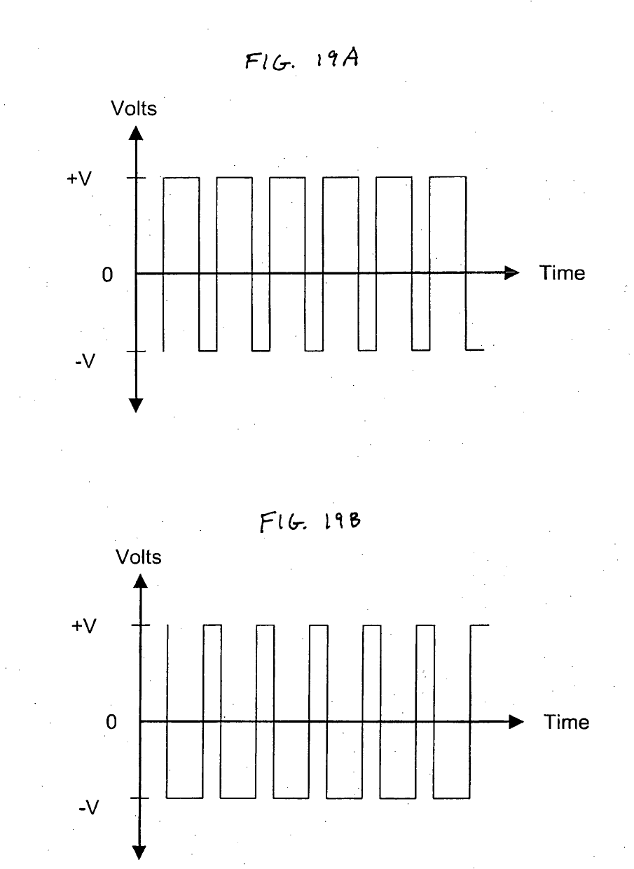

Electrically, the electromagnet drive coil 3 can be driven most simply with a bipolar DC voltage/current (one direction to open, or the opposite direction to close). A lesser current may be applied to “hold” against one stop or another. For ease of control, the current may be pulsed at relatively high frequency (well above the electrical and mechanical response bandwidth of the system, i.e., 20-200 kilohertz) as is familiar in pulse-width modulated (PWM) motor drive circuitry. And, for the purpose of providing a more controlled and slower motion of the shutter blade 8, the drive current may be pulsed at a lower frequency (i.e., 20-500 Hz). (See, FIG. 18). This effectively drives blade 8 travel in many small steps. (See, FIG. 18). The net result is a highly controllable motion. Because the start/stop forces are more balanced by inertial loading (very constant) than by friction loading (very inconsistent), this means of motion control is much more consistent and reliable at slow rates than the inconsistent stick/slip motion obtained when trying to produce slow rate travel simply by reducing DC drive level (which often results in sticks followed by jumps, or results in no motion at all). It also can be very useful, with or without feedback, to control shutter blade position for variable aperture openings. If feedback is desired, that may be provided by position sensing (i.e., optical pulses or encoder), by through-beam sensing, or by many other means. Even without any added hardware, feedback can be derived from back-EMF sensing of electromagnet drive coil 3 drive signals.

Yet another non-obvious drive option is to provide a controlled series of AC pulses, wherein the duration of positive and/or negative pulses is shorter than the electro-mechanical response bandwidth of the system. By controlling the ratio of (+) and (−) pulse times, the shutter blade 8 rotation can be driven in either direction. (See, e.g., FIG. 19A, showing a (+) dominant ratio leading to torque/motion in a direction, while FIG. 19B shows a (−) dominant ratio leading to torque/motion in the opposite direction). Reducing waste resistive power losses (which do no productive work in moving the shutter blades 8) the overall system drive energy efficiency can, in this manner, be substantially improved over straight DC drive (4× improvement has been demonstrated).

In view of the foregoing, it should be clear that numerous changes and variations can be made without exceeding the scope of the inventive concept outlined. Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A rotor magnet driven optical shutter assembly, comprising:
a) at least one electromagnetically drivable stator(s) having two ends adapted to serve as electromagnetic poles;
b) a rotatable permanent magnet rotor cooperating with at least one pole of one of said at least one stator(s), said rotor having a base end and a shutter end;
c) a shutter blade operatively connected to the shutter end of said rotor;
d) an electromagnet drive coil wound around and cooperating with at least one of said at least one stator(s) and not wound on and not around said rotor; and
e) wherein rotation of said rotor is controlled at least in part by current flow through said coil.

2. A rotor magnet driven optical shutter assembly as described in claim 1, wherein said shutter blade is rigidly connected to the shutter end of said rotor in terms of rotational motion of said rotor, such that rotation of said rotors opens and closes said shutter blade over an aperture.

3. A rotor magnet driven optical shutter assembly as described in claim 1, wherein said rotor is rotatably mounted via its base end and not via its shutter end.

4. A rotor magnet driven optical shutter assembly, comprising:
a) at least one electromagnetically drivable stator(s) having two ends adapted to serve as electromagnetic poles;
b) a rotatable permanent magnet rotor cooperating with at least one pole of one of said at least one stator(s), said rotor having a base end and a shutter end;
c) a shutter blade rigidly connected to the shutter end of said rotor in terms of rotational motion of said rotor, such that rotation of said rotors opens and closes said shutter blade over an aperture;
d) an electromagnet drive coil wound around and cooperating with at least one of said at least one stator(s); and
e) wherein rotation of said rotor is controlled at least in part by current flow through said coil.

5. A rotor magnet driven optical shutter assembly as described in claim 4, wherein said rotor is rotatably mounted via its base end and not via its shutter end

6. A rotor magnet driven optical shutter assembly, comprising:
a) at least one electromagnetically drivable stator(s) having two ends adapted to serve as electromagnetic poles;
b) a rotatable permanent magnet rotor cooperating with at least one pole of one of said at least one stator(s), said rotor having a base end and a shutter end, and said rotor being rotatably mounted via its base end and not via its shutter end;
c) a shutter blade operatively connected to the shutter end of said rotor;
d) an electromagnet drive coil wound around and cooperating with at least one of said at least one stator(s); and
e) wherein rotation of said rotor is controlled at least in part by current flow through said coil.

7. A rotor magnet driven optical shutter assembly as described in claim 6, wherein said shutter blade is rigidly connected to the shutter end of said rotor in terms of rotational motion of said rotor, such that rotation of said rotor opens and closes said shutter blade over an aperture, and wherein said drive coil is not wound on and is not around said rotor.

8. A rotor magnet driven optical shutter assembly as described in claim 7, wherein said rotor is rotated in one direction when a current is applied in one direction to said coil from an electrical source, and said rotor is rotated in an opposite direction when a current is applied to said coil in an opposite direction, such that opening and closing said shutter blade depends upon a direction of the current applied to said coil.

9. A rotor magnet driven optical shutter assembly as described in claim 7, wherein said at least one stator(s) is a plurality of stators and certain or said plurality of stators are arranged in series magnetic circuit.

10. A rotor magnet driven optical shutter assembly as described in claim 7, wherein said at least one stator(s) is a plurality of stators and some of said plurality of stators are linking stators, which linking stators are not wound by a coil.

11. A rotor magnet driven optical shutter assembly as described in claim 7, wherein said at least one stator(s) is a plurality of stators and certain of said plurality of stators are arranged in parallel magnetic circuit.

12. A rotor magnet driven optical shutter assembly as described in claim 7, including at least one other shutter blade and wherein groups of said shutter blades are evenly spaced around an aperture.

13. A rotor magnet driven optical shutter assembly as described in claim 7, including at least one other shutter blade and wherein said shutter blades are arranged on a single side of an aperture.

14. A rotor magnet driven optical shutter assembly as described in claim 7, wherein said rotor is axially offset from a cooperating pole so that an axial force in the direction of its base end is produced by the operation of said pole.

15. A rotor magnet driven optical shutter assembly as described in claim 7, wherein at least one pole cooperating with a rotor is shaped to produce varying reluctance in order to produce a torque in addition to torque produced by current through the coil.

16. A rotor magnet driven optical shutter assembly as described in claim 7, wherein the mounting of a rotor via its base end and not via its shutter end permits a shutter blade to intersect the axis of said rotor as an other rotor opens and closes said shutter blade over an aperture.

17. A rotor magnet driven optical shutter assembly as described in claim 7, wherein drive current through said drive coil is pulsed at a frequency of approximately 20-500 Hz.

18. A rotor magnet driven optical shutter assembly as described in claim 7, wherein drive current through said drive coil is pulsed at a frequency of approximately 20-200 Khz.

19. A rotor magnet driven optical shutter assembly as described in claim 7, wherein drive current through said drive coil is a controlled series of AC pulses.

20. A rotor magnet driven optical shutter assembly as described in claim 19, wherein the ratio of (+) and (−) pulse times is controlled to drive a shutter blade towards an opened or a closed position.
